(19) United States
(12) Patent Application Publication
(10) Pub. No.: US 2007/0133112 A1
(43) Pub. Date: Jun. 14, 2007

(54) Structure for concealing an automobile rear-view mirror display

(75) Inventor: Chung-Wu Chia, Jhonghe City (TW)

Correspondence Address: TROXELL LAW OFFICE PLLC, SUITE 1404, 5205 LEESBURG PIKE, FALLS CHURCH, VA, 22041, US

(73) Assignee: Rightech Corporation

(21) Appl. No.: 11/296,467

(22) Filed: Dec. 8, 2005

(51) Int. Cl. G02B 7/182

(52) U.S. Cl. 359/871; 359/838

(57) ABSTRACT

A structure for concealing an automobile rear-view mirror display that uses an automobile rear-view mirror of a front wind shield, within which is disposed a concealable multipurpose display. The automobile rear-view mirror is further internally fitted with a withdraw device. A fixed member is affixed to a side of the withdraw device, and the fixed member functions in coordination with an inlay groove of the display to secure the display, thereby enabling the display to be received and concealed within a holding recess and to be withdrawn therefrom. The automobile rear-view mirror serves as a conventional rear view mirror when the display is concealed therein, and after the multipurpose display is withdrawn from the rear-view mirror, it can be set up to serve as a car reversing video system, a satellite navigation system, a multimedia player device, a touch screen and other related functional utilities.

### BACKGROUND OF THE INVENTION

(a) Field of the Invention

The present invention provides a structure for concealing an automobile rear-view mirror display that uses a concealable multipurpose display disposed within a rear-view mirror of a front windshield.

(b) Description of the Prior Art

Referring to FIGS. 1 and 2, which show a conventional automobile rear-view mirror A that uses a display A1 disposed within a rear-view mirror A to serve as a device for receiving data and satellite navigation. In the wake of rapid development in science and technology, and the varied needs of different users, the display A1 has been configured with additional functions, including ability to serve as a video media player and multimedia player device. However, different changes in image coloration easily result in unacceptable viewing for the user because of corresponding unclear transmission through a glass mirror A2 of the display A1 and haziness of the glass mirror A2 surface.

Thus, it is a feature of the present invention to provide a structure for concealing an automobile rear-view mirror display that overcomes the aforementioned shortcomings of prior art.

### SUMMARY OF THE INVENTION

The present invention provides a structure for concealing an automobile rear-view mirror display that uses a concealable multipurpose display disposed in the interior of an automobile rear-view mirror of a front wind shield and a withdraw device fitted within the automobile rear-view mirror. A fixed member of the withdraw device functions in coordination with an inlay groove of the display to secure the display, thereby enabling the display to be received and concealed within a holding recess and to be withdrawn therefrom to function as a display.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of a conventional automobile rear-view mirror.

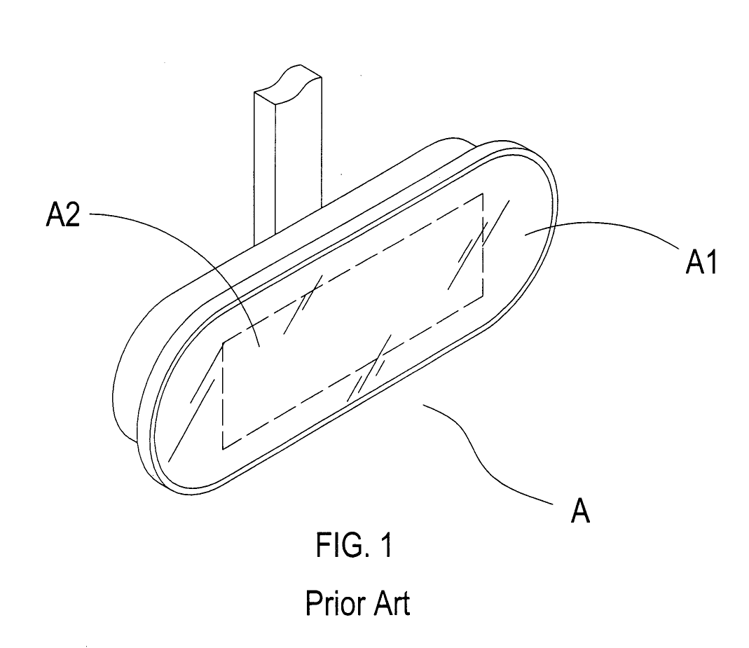

FIG. 2 shows a schematic elevational view of a conventional automobile rear-view mirror in use.

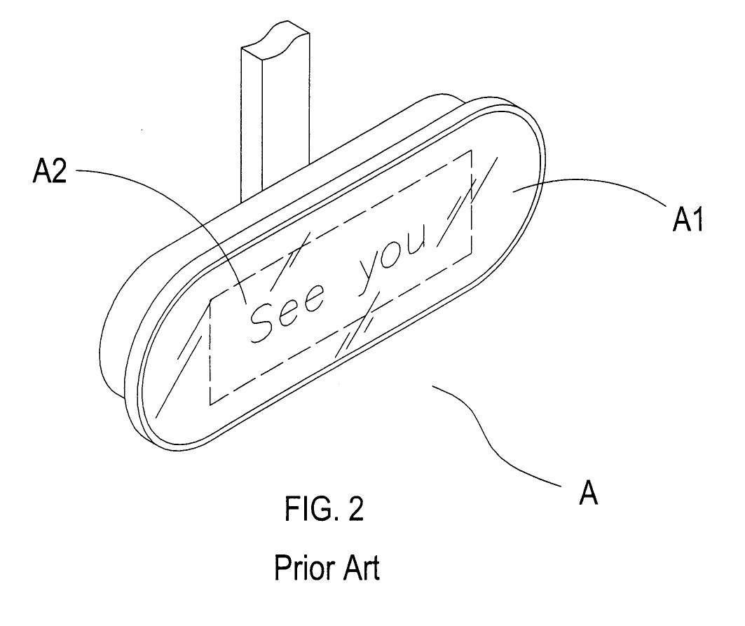

FIG. 3 shows an elevational view according to the present invention.

FIG. 4 shows an exploded elevational view according to the present invention.

FIG. 5 shows a cutaway elevational view of the first embodiment according to the present invention.

FIG. 6 shows a cutaway elevational view depicting the second embodiment of the present invention.

FIG. 7 shows an elevational view depicting the third embodiment of the present invention.

FIG. 8 shows a rear elevational view of the fourth embodiment of the present invention.

### DETAILED DESCRIPTION OF THE PREFERRED EMBODIMENTS

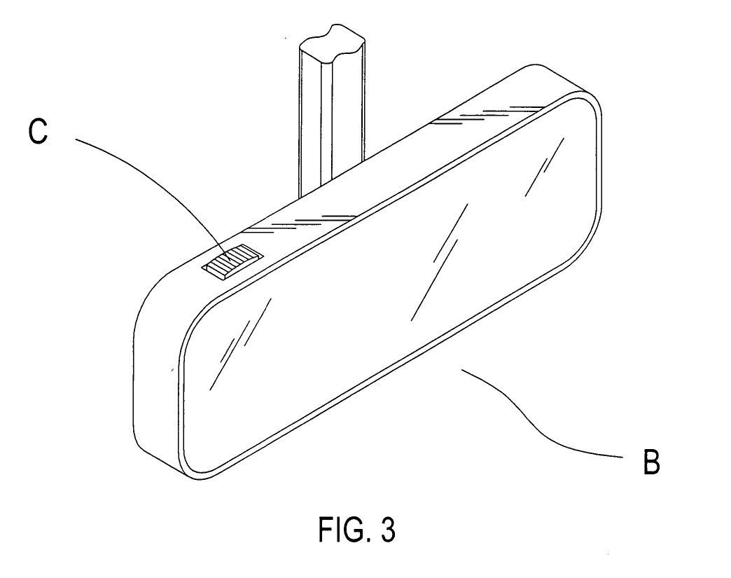

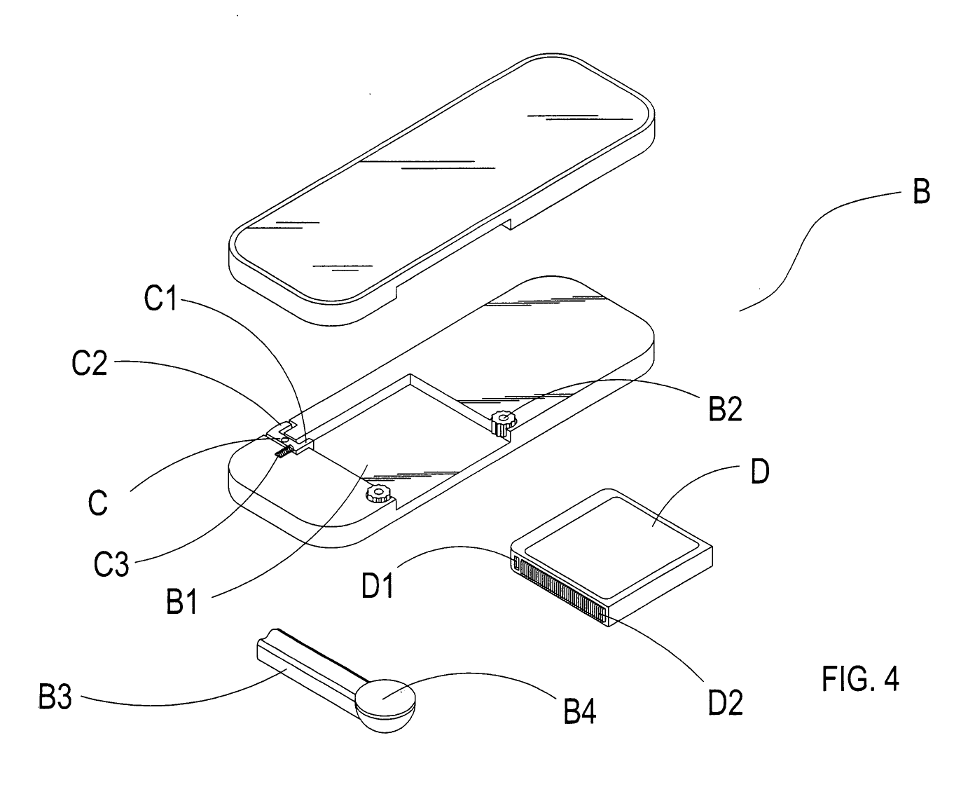

Referring to FIGS. 3 and 4, which show a structure for concealing an automobile rear-view mirror display of the present invention structured to comprise an automobile rear-view mirror B, a withdraw device C and a display D. The present invention is characterized in that:

The automobile rear-view mirror B of a front windshield is provided with a holding recess B1 for receiving and concealing the display D and clamp devices B2. Moreover, the automobile rear-view mirror B, a support B3 and an adjustable adjustment mount B4 enable a user to have a clear view of what is at the rear of the vehicle.

The withdraw device C is fitted with a fixed member C1 that functions in coordination with a press button C2, and together with a flexible spring C3, further functions in coordination with an inlay groove D1 of the display D to enable the display D to be retracted and concealed within the holding recess B1, thereby providing functionality to withdraw the display D.

The display D is further provided with ancillary edges D2, and the inlay groove D1 functions in coordination with the fixed member C1 and the clasp devices B2 of the holding recess B1, which together with the ancillary edges D2 of the display D enable the entire configuration to achieve a coordinative mechanism for concealing and withdrawing the display D.

When the display D is concealed within the automobile rear-view mirror B, the automobile rear-view mirror B serves as a conventional rear view mirror, and after the multipurpose display D is withdrawn from the rear-view mirror B, it can provide additional functional purposes, including encouraging safe driving and providing multimedia entertainment.

After the multipurpose display D is withdrawn from the rear-view mirror B and is operating, the display D can be set up to serve as a car reversing video system, a satellite navigation system, a multimedia player device, a touch screen and other related functional utilities that encourage safe driving and provide multimedia entertainment.

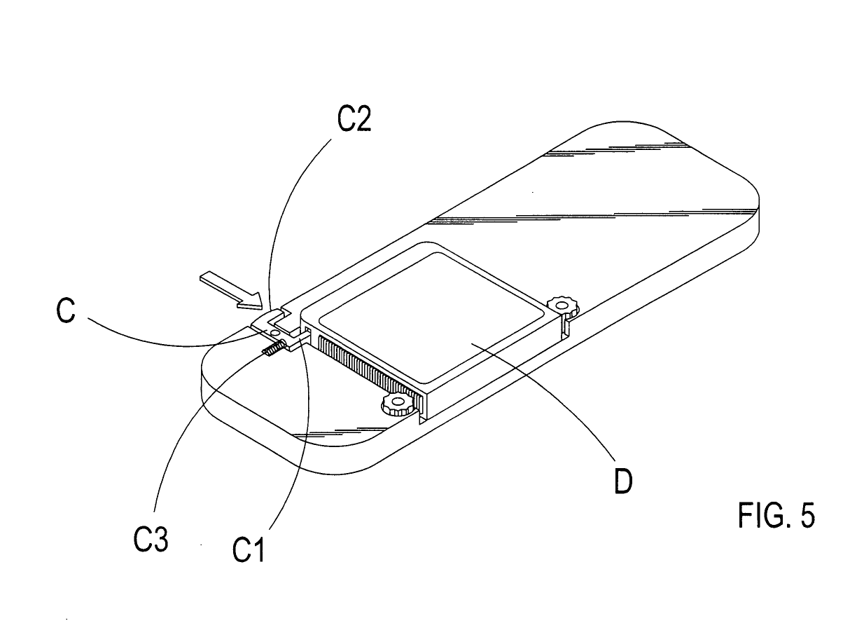

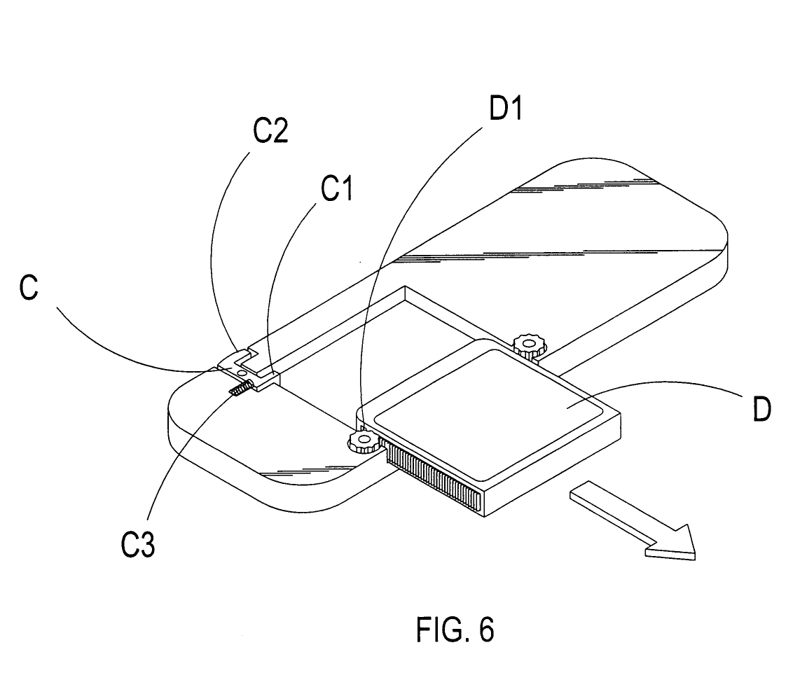

Referring to FIGS. 5 and 6, which show an embodiment of the present invention. When the display D is concealed within the automobile rear-view mirror B, the automobile rear-view mirror B serves as a conventional rear-view mirror. A user presses the press button C2 to enable the display D to extend and retract back and forth by means of the fixed member C1 and the spring C3, which enable the inlay groove D1 of the display D to separate from the fixed member C1 of the withdraw device C, thereby causing the display D to withdraw from the rear-view mirror B.

The clasp devices B2 of the holding recess B1 and the ancillary edges D2 enable progressive withdrawal of the display D from the rear-view mirror B, whereafter the multipurpose display D can be set up as a car reversing video system, a satellite navigation system, a multimedia player device, a touch screen and other related functional utilities that encourage safe driving and provide multimedia entertainment.

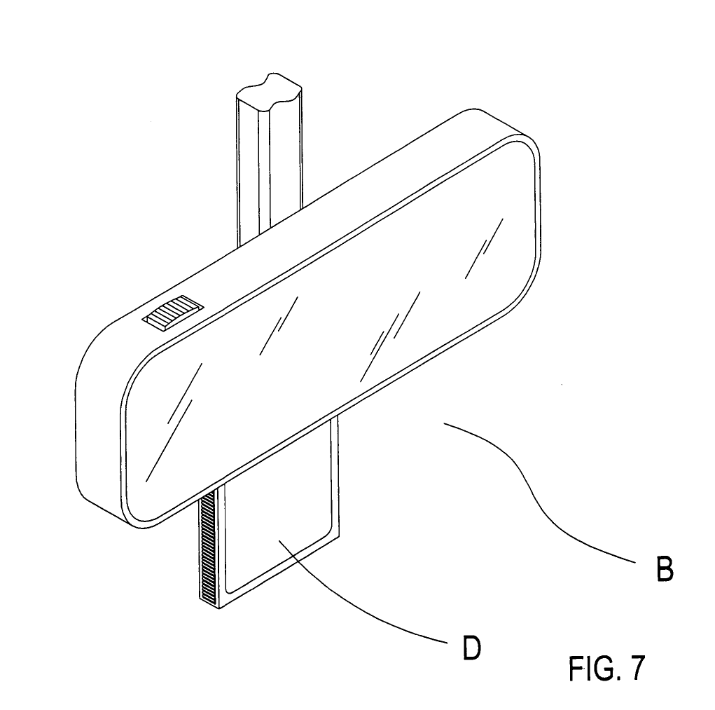

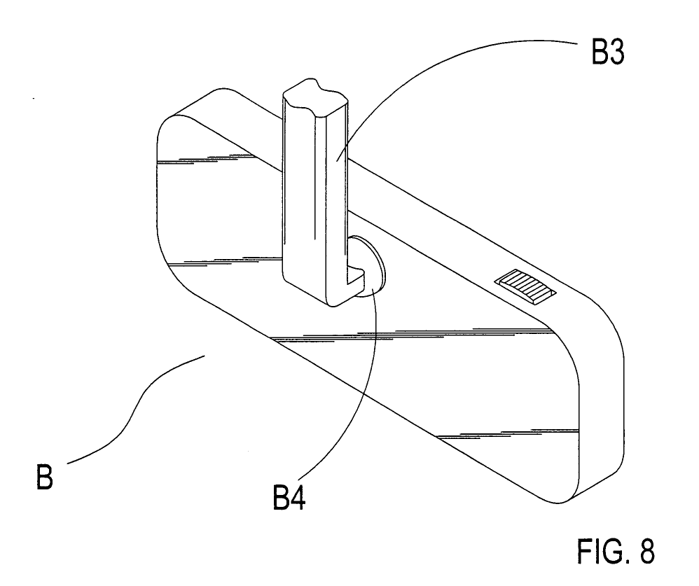

Referring to FIGS. 7 and 8, the automobile rear-view mirror B is adequately supported by the support B3, and adjusted to an appropriate angle by means of the adjustment mount B4, thereby enabling the user to have a clear view of what is at the rear of the car. Moreover, appropriate disposition of the automobile rear-view mirror B enables the display D to be withdrawn and used without occupying a lot of space within the car or obstructing the line of vision of the user. Furthermore, it achieves the use objective of encouraging safe driving.

The automobile rear-view mirror B, the support B3, the adjustment mount B4 and the display D are separately installable and replaceable devices, thereby facilitating the user to separately replace the automobile rear-view mirror B, the support B3, the adjustment mount B4 and the display D, and enable easy maintenance thereof, and effectively saving on manufacturing costs.

In order to better explicitly disclose advancement and practicability of the present invention, a comparison with conventional art is described hereinafter:

Shortcomings of conventional art:

1. The display of the conventional automobile rear-view mirror lacks the functionality to be withdrawn from the rear-view mirror and function as a display.

2. An unclear surface of a glass mirror of the conventional automobile rear-view mirror results in unacceptable viewing for the user.

3. Different changes in image coloration affect the quality of display transmission.

Advantages of the present invention:

1. The display D of the automobile rear-view mirror B has functionality to be concealed within and withdrawn from the rear-view mirror B.

2. Does not occupy space within the car, and does not obstruct the line of vision of the user.

3. Provides for separate replacement of individual component devices, thereby facilitating the user to replace and maintain the components.

4. The display D has multifunctional uses, and achieves the objective of encouraging safe driving and providing multimedia entertainment.

5. Provided with advancement and practicability.

6. Enhances commercial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent, application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A structure for concealing an automobile rear-view mirror display, comprising a concealable multipurpose display disposed in the interior of an automobile rear-view mirror of a front wind shield and a withdraw device fitted within the automobile rear-view mirror, a fixed member is affixed to a side of the withdraw device, and the fixed member functions in coordination with an inlay groove of the display to secure the display, thereby enabling the display to be received and concealed within a holding recess and to be withdrawn therefrom to function as a display; the automobile rear-view mirror serves as a conventional rear view mirror when the display is concealed therein, and after the multipurpose display is withdrawn from the rear-view mirror, it can be set up to serve as a car reversing video system, a satellite navigation system, a multimedia player device, a touch screen and other related functional utilities that provide information for safe driving and for entertainment use.

2. The structure for concealing an automobile rear-view mirror display according to claim 1, wherein the withdraw device is further configured as a flexible spring device, an extract device, an automatic device, a remove device, a fixed device and related remove devices that can be concealed and are movable.

3. The structure for concealing an automobile rear-view mirror display according to claim 1, wherein the multipurpose display further comprises gear shafts, rotating gears, movable slide grooves and related structural devices that function in coordination with the withdraw device to enable concealing and withdrawing the multipurpose display.
